(19) United States
(12) Patent Application Publication
(10) Pub. No.: US 2021/0064239 A1
(43) Pub. Date: Mar. 4, 2021

(54) APPARATUS AND METHOD FOR CONTROLLING MULTI-ACTUATOR HARD DISK DRIVES

(71) Applicant: Microchip Technology Inc., Chandler, AZ (US)

(72) Inventor: Robert E. Caldwell, Jr., Orlando, FL (US)

(73) Assignee: Microchip Technology Inc., Chandler, AZ (US)

(21) Appl. No.: 16/588,976

(22) Filed: Sep. 30, 2019

Related U.S. Application Data
(60) Provisional application No. 62/894,623, filed on Aug. 30, 2019.

(51) Int. Cl. G06F 3/06; G06F 13/42

(52) U.S. Cl. CPC G06F 3/064; G06F 3/0658; G06F 3/0607; G06F 13/4221; G06F 3/0674; G06F 3/0659

(57) ABSTRACT

A method for writing data to a dual-actuator disk drive includes providing a multi-actuator disk drive having a first actuator communicating with first disk platters and a second actuator communicating with second disk platters, receiving in a storage controller coupled to the disk drive a data stream including groups of blocks of data to be written to the multi-actuator disk drive, alternately distributing from a disk controller in the disk drive sequential ones of the groups of blocks of data from the data stream to the first actuator and the second actuator as defined by commands from the storage controller, and simultaneously writing from the first actuator to the at least one first disk platter ones of the groups of blocks of data routed to the first actuator and writing from the second actuator to the at least one second disk platter ones of the groups of blocks of data routed to the second actuator.

### FIELD OF THE INVENTION

The present invention relates to disk drive storage and control of disk drive storage. More particularly, the present invention relates to multi-actuator disk drives and control of multi-actuator disk drives.

### BACKGROUND

Hard Disk Drive (HDD) actuators are the electromechanical arms that move the read/write heads to the relevant locations within the HDD. Until recently, all the read/write heads in the HDD have been attached to a single actuator. A single actuator has the capability to “seek” to any Logical Block Address (LBA) on the HDD. A conventional HDD presents a single Logical Unit Number (LUN), LUN 0, to the host initiator.

Disk drive manufacturers are in the process of developing and releasing multi-actuator Hard Disk Drives (HDDs). These drives have the potential to multiply the current HDD bandwidth and input-output operations per second (IOPs) ratings of a conventional single actuator HDD by a factor equal to the number of actuators included in the HDD. Multi-actuator HDDs divide the total LBA range of the device into roughly equal portions, one for each actuator. Each actuator can only access its “portion” of the LBA range. Each actuator is presented as a separate LUN within the HDD.

The first examples of multi-actuator HDDs are expected to be Dual Actuator. Dual actuator HDDs are expected to use at least two independent stacked actuators with each addressing a different set of platters within the disk drive, each platter set having a storage capacity of approximately a pro-rata share of the total LBA space. These actuators are expected to be represented as LUN 0 and LUN 1 of the HDD. As additional actuators may be added in the future, this addressing scheme is likely to continue.

From the host initiator perspective, this represents the equivalent of multiple distinct HDDs, each with its own LBA range and capacity. However, in order to achieve the increased bandwidth and input/output operations per second (IOPS) potential offered in these devices, the host initiator must utilize simultaneous access to multiple LUNs. Each single LUN within the HDD can only provide the bandwidth and IOPS capacity of a standard single actuator HDD.

### BRIEF DESCRIPTION

According to an aspect of the invention, a method for writing data to a multi-actuator disk drive includes providing a multi-actuator disk drive having a first actuator communicating with at least one first disk platter and a second actuator communicating with at least one second disk platter, receiving in a storage controller coupled to the multi-actuator disk drive a data stream including groups of blocks of data to be written to the multi-actuator disk drive, alternately distributing from a disk controller in the multi-actuator disk drive sequential ones of the groups of blocks of data from the data stream to the first actuator and the second actuator as defined by commands from the storage controller, and simultaneously writing from the first actuator to the at least one first disk platter ones of the groups of blocks of data routed to the first actuator and writing from the second actuator to the at least one second disk platter ones of the groups of blocks of data routed to the second actuator.

According to an aspect of the invention, alternately distributing from the disk controller sequential ones of the groups of blocks of data from the data stream to the first actuator and the second actuator includes alternately distributing from the disk controller chunksize groups of blocks.

According to an aspect of the invention, the chunksize is chosen to be less than one half of an average write request size.

According to an aspect of the invention, a method for reading data from a multi-actuator disk drive includes providing a multi-actuator disk drive having a first actuator communicating with at least one first disk platter and a second actuator communicating with at least one second disk platter, simultaneously reading from the at least one first disk platter to the first actuator groups of blocks of data routed to the first actuator and reading from the at least one second disk platter to the second actuator groups of blocks of data routed to the second actuator, sending the groups of blocks of data from the first actuator and the second actuator to a disk controller in the multi-actuator disk drive, assembling in the disk controller a data stream containing the groups blocks of data received from the first actuator and the second actuator, and sending the data stream to a storage controller coupled to the multi-actuator disk drive.

According to an aspect of the invention, sending the groups of blocks of data from the first actuator and the second actuator to a disk controller in the multi-actuator disk drive includes sending to the disk controller chunksize groups of blocks of data.

According to an aspect of the invention, the chunksize is chosen to be less than one half of an average read request size.

According to an aspect of the invention, a multi-actuator disk drive system includes a multi-actuator disk drive having a first actuator communicating with at least one first disk platter and a second actuator communicating with at least one second disk platter, a storage controller coupled to the multi-actuator disk drive and configured to receive a data stream including groups of blocks of data to be written to the multi-actuator disk drive, to alternately route to the disk controller sequential ones of the groups of blocks of data from the data stream to the first actuator and the second actuator. The multi-actuator disk drive is further configured to simultaneously write from the first actuator to the at least one first disk platter ones of the groups of blocks of data routed to the first actuator and write from the second actuator to the at least one second disk platter ones of the groups of blocks of data routed to the second actuator.

According to an aspect of the invention, the storage controller is configured to receive a data stream including chunksize groups of blocks of data to be written to the multi-actuator disk drive, to alternately route from the disk controller sequential ones of the chunksize groups of blocks of data from the data stream to the first actuator and the second actuator.

According to an aspect of the invention, the chunk size is chosen to be less than one half of an average write request size.

According to an aspect of the invention, the multi-actuator disk drive is further configured to simultaneously write via the first actuator to the at least one first disk platter ones of the chunksize groups of blocks of data routed to the first actuator and write via the second actuator to the at least one second disk platter ones of the chunksize groups of blocks of data routed to the second actuator.

According to an aspect of the invention, the chunksize is chosen to be less than one half of an average write request size.

According to an aspect of the invention, the multi-actuator disk drive is further configured to simultaneously read from the at least one first disk platter through the first actuator ones of the blocks of data routed to the first actuator and read from the at least one second disk platter through the second actuator ones of the blocks of data routed to the second actuator, send the blocks of data from the first actuator and the second actuator to a disk controller in the multi-actuator disk drive, assemble in the disk controller a data stream containing the groups of blocks of data received from the first actuator and the second actuator, and send the data stream to a storage controller coupled to the multi-actuator disk drive.

### BRIEF DESCRIPTION OF THE DRAWING FIGURES

The invention will be explained in more detail in the following with reference to embodiments and to the drawing in which are shown:

FIG. 1 is a block diagram that illustrates a data processing system and shows how a user or host OS would organize user applications in a conventional way to employ multi-actuator disk drive storage;

FIG. 2 is a block diagram that illustrates a way that user or host OS can organize user applications to employ multi-actuator disk drive in accordance with an aspect of the present invention;

FIG. 3 is a flow diagram showing the operation of the present invention;

FIG. 4 is a flow diagram showing a method for writing data to a multi-actuator disk drive in accordance with an aspect of the present invention; and

FIG. 5 is a drawing showing a method for reading data from a multi-actuator disk drive in accordance with an aspect of the present invention.

### DETAILED DESCRIPTION

Persons of ordinary skill in the art will realize that the following description is illustrative only and not in any way limiting. Other embodiments will readily suggest themselves to such skilled persons.

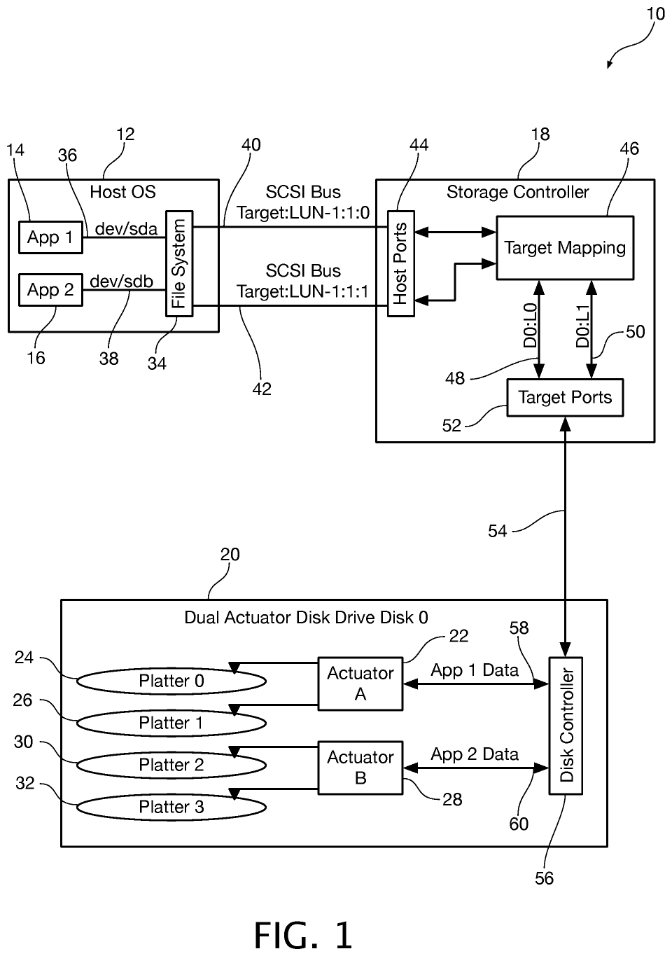

Referring now to FIG. 1, a block diagram of a data processing system 10 including a host operating system (OS) 12 running two applications App1 14, and App2 16, coupled to a storage controller 18 that controls a dual actuator disk drive 20 designated as Disk 0. The dual actuator disk drive 20 includes an actuator A 22 writing to and reading from platters 24 and 26, and an actuator B 28 writing to and reading from platters 30 and 32.

Disk 0 (dual actuator disk drive 20) presents LUN 0 for actuator A 22 of Disk 0 and LUN 1 for actuator B 28 of Disk 0 through the storage controller 18 to the host OS 12. The host file system 34 in the OS 12 creates two storage device nodes dev/sda shown at reference numeral 36 and dev/sdb shown at reference numeral 38 as logical volumes for user data storage. The OS 12 assigns dev/sda 36 to App1 14 and dev/sdb 38 to App2 16. The file system 34 in the OS 12 sends data from App1 14 to the storage controller 18 as target LUN-1:1:0 shown conceptually at reference numeral 40 and sends data from App2 16 to the storage controller 18 as the target LUN-1:1:1 shown conceptually at reference numeral 42. The host ports 44 in the storage controller 18 route the data to target mapping unit 46, which creates data streams for actuator A 22 as D0:L0 at reference numeral 48 and for actuator B 28 as D0:L1 at reference numeral 50 and directs them to target ports 52.

The target ports 52 in storage controller 18 direct data to and from the dual actuator disk drive 20 into, and out of, the storage controller 18 across connection 54 from the disk controller 56 in the dual actuator disk drive 20. The disk controller 56 passes App1 data on lines 58 to actuator A 22 for reading/writing platters 24 and 26, and App2 data on lines 60 to actuator B 28 for reading/writing platters 30 and 32.

In the example shown in FIG. 1, the workloads of applications App1 14 and App2 16 must both be sufficient and balanced to achieve the full rated performance of the multi-actuator disk drive. If either of the applications has a workload that is insufficient to saturate its actuator, then the drive cannot achieve its full rated performance.

In the present invention, each LUN of the multi-initiator HDD within the controller is treated as a distinct storage entity and striping is applied across the LUNs.

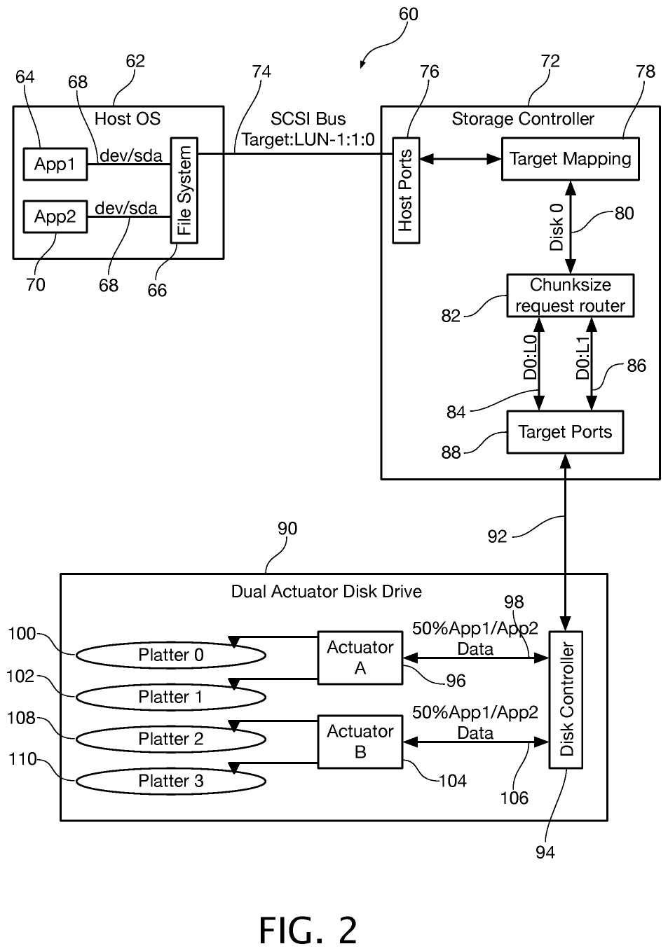

Referring now to FIG. 2, a block diagram of a data processing system 60 represents how the storage controller abstracts the multi-actuator disk drive as a single-actuator disk drive using a chunksize request router in the form of a firmware layer in accordance with an aspect of the invention. The user then takes advantage of the increased performance of a multi-actuator disk drive without multiple applications or load balancing. While a dual-actuator disk drive is depicted, those skilled in the art will understand this this is a non-limiting example of multi-actuator drive.

The host OS 62 is shown running two applications. A first application App1 is identified by reference numeral 64. The file system 66 creates a single storage device node dev/sda shown at reference numeral 68 as a logical volume for user data storage from App1 64. A second application App2 is identified by reference numeral 70. The file system 66 uses the same storage device node dev/sda shown at reference numeral 68 as a logical volume for user data storage from App2 70.

The file system 64 in the host OS 62 sends data from both App1 64 and App2 70 to the storage controller 72 as target LUN-1:1:0 shown conceptually at reference numeral 74. The host ports 76 in the storage controller 72 route the data to target mapping unit 78, which creates a single data stream as Disk 0 at reference numeral 80 and directs it to chunksize request router 82. The chunksize request router 82 may be implemented as a firmware layer in the storage controller 72 and creates two data streams D0:L0 at reference numeral 84 and D0:L1 at reference numeral 86 that are sent to target ports 88. The data streams D0:L0 at reference numeral 84 and D0:L1 at reference numeral 86 each contain data from both App1 64 and App2 70 in the host OS 62.

These data streams D0:L0 at reference numeral 84 and D0:L1 at reference numeral 86 are sent to the dual actuator disk drive 90 over line 92 and are received by disk controller 94. The disk controller 94 sends data to, and receives data from, actuator A 96 over line 98. Actuator A 96 writes and reads data from platters 100 and 102. The disk controller 94 also sends data to, and receives data from, actuator B 104 over line 106. Actuator B 104 writes and reads data from platters 108 and 110. Persons of ordinary skill in the art will appreciate that the disk controller 94 buffers and distributes the data to both Actuator A 96 and Actuator B 104 as is known in the art, and buffers and assembles the data from both Actuator A 96 and Actuator B 104 as is known in the art, and is shown by the bidirectional lines 98 and 106.

The maximum amount of data supplied to each of actuator A 96 and actuator B 104 is 50% App1 data and 50% App2 data regardless of the relative sizes of the App1 data files and the App2 data files because each actuator can provide no more than 50% of the performance of the entire disk drive.

The apparatus and method of the present invention allows any workload to be divided into roughly equal parts and distributed across the available HDD actuators. The user is not required to partition storage according to HDD actuator geometry to achieve the performance multiplying effect of the multi-actuator HDD.

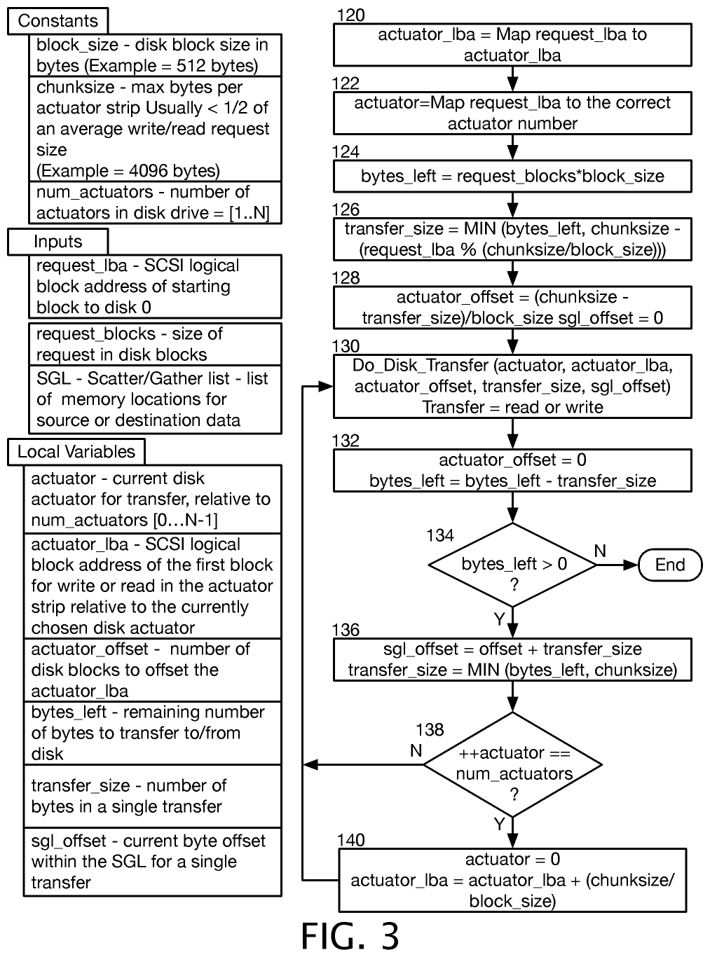

Referring now to FIG. 3, a flow chart shows the operation of the present invention. Persons of ordinary skill in the art will appreciate that FIG. 3 presents one non-limiting example of the operation of the present invention and that multi-actuator disk systems can be operated in accordance with the present invention using parameters, such as, but not limited to, block_size and chunksize parameters, other than those stated in FIG. 3 and its accompanying description. The method of FIG. 3 is performed by chunksize request router 82 running in storage controller 72. Alternatively, the method of FIG. 3 may be performed by a processor and related memory in storage controller 72, without exceeding the scope.

It is useful to define several terms used in the flow chart of FIG. 3.

As used herein the term “block” refers to the smallest addressable unit size of the dual actuator disk drive where one block equals the number of bytes in block_size, where block_size is some number of bytes that is defined by formatting information provided by the disk drive.

The quantity chunksize is some number of bytes that is a whole number multiple of block_size. The quantity blocks_per_chunk refers to a whole number multiple of block_size bytes required to make chunksize bytes, i.e., blocks_per_chunk=chunksize/block_size. An optimal chunksize is preferably chosen to be less than one half of an average I/O request (i.e., WRITE request and READ request) size. This assures that more than half of the I/O requests would utilize both actuators.

The term integer math refers to math using only integer numbers; no decimal or fractional remainders.

The term modulo refers to a mathematical method (using the % symbol) for expressing the remainder of a division as the numerator of the remaining fraction. As an example, 22% 5=2 (because 22/5=4+⅖ where 2 is the numerator of the fractional remainder).

The term MA refers to a Multi-Actuator disk drive.

### Flowchart Descriptions

At reference numeral 120, a new request is presented and the Logical Block Address (LBA) of the first block in the chunksize boundary where the request_lba (the first LBA in the new request) falls is determined using integer math. Persons of ordinary skill in the art will appreciate that the new request can be either a read request or a write request. Assume the addressable blocks of a multi-actuator (MA) disk drive are divided equally amongst the num_actuators (N), this gives each actuator access to (1/N) of the total addressable blocks on the disk. Relative to each actuator, its blocks are addressable as blocks [0..(total disk blocks/(N−1))]. Each chunk (or strip) is the number of blocks which add up to the chunksize. In this example, the chunksize is 4096 bytes which is 8 blocks where block_size=512 bytes. The LBA of the first block in the chunksize boundary where the request_lba falls, is denoted actuator_lba, and is determined by

actuator_lba=(request_lba/(blocks_per_chunk*num_actuators))*blocks_per_chunk

At reference numeral 122, the actuator number [0..N−1] where the request_lba is located is determined. Given that a MA disk's total addressable blocks are divided equally amongst the number of actuators (N), any given request_lba must reside within exactly one actuator's domain. The actuator number [0..N−1] where the request_lba is located is determined using integer math, and is denoted actuator. This can be done by modulo arithmetic

actuator=(request_lba/blocks_per_chunk) % num_actuators

At reference numeral 124, the flowchart uses a variable bytes_left to store the total number of bytes that still need to be transferred from/to the disk. The input (new request at reference numeral 120) is always a READ or WRITE request for some number of blocks starting at a particular block (request_lba). Initially variable bytes_left is the entire request size and is set to

request_blocks*block_size

At reference numeral 126, the variable “transfer_size” is defined as the number of bytes to be transferred in the current transfer operation. The request_lba may fall on any block boundary within the chunksize. The initial transfer_size may be less that a full chunksize depending on where the request_lba falls within the chunk. The initial transfer_size is the lesser of bytes_left and the number of bytes from the request_lba to the end of chunksize. This can be expressed as

transfer_size=MIN(bytes_left, chunksize−(request_lba % (chunksize/block_size)))

At reference numeral 128, the actuator offset, denoted actuator_offset is determined. The actuator_offset is the number of blocks that must be skipped over starting from actuator_lba to get to the block within chunksize where the request_lba is located. This can be expressed as

actuator_offset=(chunksize−transfer_size)/block_size

The Scatter/Gather List (SGL) describes the list of various memory locations for the READ or WRITE data. The SGL is a list of memory pages located in either the host OS 62 or the storage controller 72. Each separate disk transfer uses a different part of the SGL. The sgl_offset is the number of bytes to skip over in the host SGL. The sgl_offset increases with each transfer by the number of bytes in the previous transfer. The initial value is

sgl_offset=0

At reference numeral 130, a command is issued to the dual actuator disk drive 90 to exchange data between the dual actuator disk drive 90 and the memory pages described by the SGL. Do_Disk_Transfer is a representation of a standard storage controller function or set of functions used to create a SCSI, SAS, SATA or NVMe, without limitation, request packet. This is a subsystem used to communicate READ and WRITE requests to a disk drive, such as dual actuator disk drive 90. Do_Disk_Transfer will issue a command to the dual actuator disk drive 90 for both READ and WRITE transfers of groups of block having sizes up to chunk_size groups of blocks, and exchange the data between the dual actuator disk drive 90 and the memory pages described by the SGL. The transfer will complete at some point in the future. The completion mechanism is not relevant to the present invention, and is known to those skilled in the art.

At reference numeral 132, first the actuator_offset is reset to 0 and the number of bytes left to be transferred is reduced. Once the first disk transfer has been issued, all subsequent transfers for this request will begin on a chunksize boundary. The actuator_offset is no longer needed and is set to zero by

actuator_offset=0

The variable bytes_left is then reduced by the number of bytes transferred in the previous Do_Disk_Transfer.

bytes_left=bytes_left−transfer_size

At reference numeral 134, if the remaining bytes to transfer is equal to zero, the request is complete, and the method terminates and returns. If the remaining bytes to transfer is non-zero, the method proceeds to reference numeral 136, where the new location of the READ or WRITE data within the SGL is identified. The sgl_offset is adjusted by the number of bytes transferred in the previous Do_Disk_Transfer. The new location of the READ or WRITE data within the SGL is identified by

sgl_offset=sgl_offset+transfer_size

The transfer_size for the next transfer will be the lesser of the bytes_left or a chunksize and is expressed as

transfer_size=MIN(bytes_left, chunksize)

At reference numeral 138, the method now chooses the disk actuator for the next transfer. The actuator_lba is relative to each actuator. For any given actuator_lba, each actuator has chunksize bytes at that location. The same actuator_lba on every actuator of the disk creates a row. The row size is num_actuators*chunksize. After each transfer, the actuator number is incremented. When the actuator number reaches the number of actuators (N), the transfer must move to the next row and reset the actuator number to zero. When the row increases, the actuator_lba must be increased by the blocks_per_chunk. This assures that the data is distributed essentially equally across all of the actuators. In a dual actuator disk drive, this assures that the data is alternately written to the two actuators.

If the result at reference numeral 138 is that the next actuator number does not equal num_actuators, the method returns to reference numeral 130.

If the result at reference numeral 138 is that the next actuator number equals num_actuators, the method proceeds to reference numeral 140, where the actuator number is reset to 0 and the actuator_lba is increased by the blocks_per_chunk. The method then returns to reference numeral 130.

Persons of ordinary skill in the art will appreciate that the method shown in FIG. 3 can be performed much more quickly than the actual data transfers performed by the actuators A 96 and B 104 in response to the method shown in FIG. 3. In addition, the chunksize request router 82 may issue multiple disk transfer commands to each actuator of the dual actuator disk drive. Accordingly, the actual data transfers are being simultaneously performed by both actuator A 22 and actuator B 28.

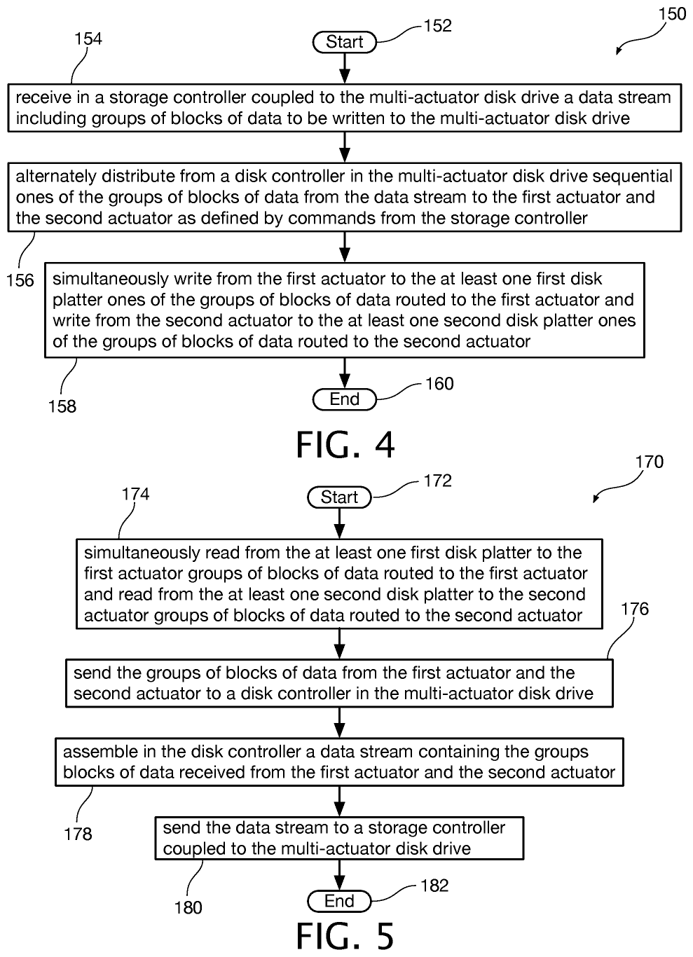

Referring now to FIG. 4, a flow diagram shows a method 150 for writing data to a multi-actuator disk drive in accordance with an aspect of the present invention. The method begins at reference numeral 152.

At reference numeral 154, a data stream including groups of blocks of data to be written to the multi-actuator disk drive is received in a storage controller coupled to the multi-actuator disk drive. At reference numeral 156, sequential ones of the groups of blocks of data from the data stream are alternately distributed from a disk controller in the multi-actuator disk drive to the first actuator and the second actuator as defined by commands from the storage controller. At reference numeral 158, ones of the groups of blocks of data routed to the first actuator are written from the first actuator to the at least one first disk platter and ones of the groups of blocks of data routed to the second actuator are written from the second actuator to the at least one second disk platter. The writing from the first and second actuators is performed simultaneously. The method ends at reference numeral 160.

Referring now to FIG. 5, a drawing shows a method 170 for reading data from a multi-actuator disk drive in accordance with an aspect of the present invention. The method begins at reference numeral 172.

At reference numeral 174, groups of blocks of data are read from the at least one first disk platter and routed to the first actuator and groups of blocks of data are read from the at least one second disk platter and routed to the second actuator. The reading and routing to the first and second actuators is performed simultaneously.

At reference numeral 176, the groups of blocks of data from the first actuator and the second actuator are sent to a disk controller in the multi-actuator disk drive. At reference numeral 178, a data stream containing the groups blocks of data received from the first actuator and the second actuator are assembled in the disk controller. At reference numeral 180, the data stream is sent to a storage controller coupled to the multi-actuator disk drive. The method ends at reference numeral 182.

While embodiments and applications of this invention have been shown and described, it would be apparent to those skilled in the art that many more modifications than mentioned above are possible without departing from the inventive concepts herein. The invention, therefore, is not to be restricted except in the spirit of the appended claims.

What is claimed is:

1. A method for writing data to a multi-actuator disk drive comprising:
providing a multi-actuator disk drive having a first actuator communicating with at least one first disk platter and a second actuator communicating with at least one second disk platter;
receiving in a storage controller coupled to the multi-actuator disk drive a data stream including groups of blocks of data to be written to the multi-actuator disk drive;
alternately distributing from a disk controller in the multi-actuator disk drive sequential ones of the groups of blocks of data from the data stream to the first actuator and the second actuator as defined by commands from the storage controller; and
simultaneously writing from the first actuator to the at least one first disk platter ones of the groups of blocks of data routed to the first actuator and writing from the second actuator to the at least one second disk platter ones of the groups of blocks of data routed to the second actuator.

2. The method of claim 1 wherein alternately distributing from the disk controller sequential ones of the groups of blocks of data from the data stream to the first actuator and the second actuator comprises alternately distributing from the disk controller up to chunksize groups of blocks.

3. The method of claim 2 wherein the chunksize is chosen to be less than one half of an average write request size.

4. A method for reading data from a multi-actuator disk drive comprising:
providing a multi-actuator disk drive having a first actuator communicating with at least one first disk platter and a second actuator communicating with at least one second disk platter;
simultaneously reading from the at least one first disk platter to the first actuator groups of blocks of data routed to the first actuator and reading from the at least one second disk platter to the second actuator groups of blocks of data routed to the second actuator;
sending the groups of blocks of data from the first actuator and the second actuator to a disk controller in the multi-actuator disk drive;
assembling in the disk controller a data stream containing the groups blocks of data received from the first actuator and the second actuator; and
sending the data stream to a storage controller coupled to the multi-actuator disk drive.

5. The method of claim 4 wherein sending the groups of blocks of data from the first actuator and the second actuator to a disk controller in the multi-actuator disk drive comprises sending to the disk controller chunksize groups of blocks of data.

6. The method of claim 5 wherein the chunksize is chosen to be less than one half of an average read request size.

7. A multi-actuator disk drive system comprising:
a multi-actuator disk drive having a first actuator communicating with at least one first disk platter and a second actuator communicating with at least one second disk platter;
a storage controller coupled to the multi-actuator disk drive and configured to receive a data stream including groups of blocks of data to be written to the multi-actuator disk drive, and to alternately route to the disk controller sequential ones of the groups of blocks of data from the data stream to the first actuator and the second actuator;
the multi-actuator disk drive further configured to simultaneously write from the first actuator to the at least one first disk platter first ones of the groups of blocks of data routed to the first actuator and write from the second actuator to the at least one second disk platter second ones of the groups of blocks of data routed to the second actuator.

8. The multi-actuator disk drive system of claim 7 wherein the storage controller is configured to receive a data stream including chunksize groups of blocks of data to be written to the multi-actuator disk drive, to alternately route from the disk controller sequential ones of the chunksize groups of blocks of data from the data stream to the first actuator and the second actuator.

9. The method of claim 8 wherein the chunk size is chosen to be less than one half of an average write request size.

10. The multi-actuator disk drive system of claim 7 wherein the multi-actuator disk drive is further configured to simultaneously write via the first actuator to the at least one first disk platter ones of the chunksize groups of blocks of data routed to the first actuator and write via the second actuator to the at least one second disk platter ones of the chunksize groups of blocks of data routed to the second actuator.

11. The method of claim 10 wherein the chunksize is chosen to be less than one half of an average write request size.

12. The multi-actuator disk drive system of claim 7, wherein:
the multi-actuator disk drive is further configured to simultaneously read from the at least one first disk platter through the first actuator ones of the blocks of data routed to the first actuator and read from the at least one second disk platter through the second actuator ones of the blocks of data routed to the second actuator, send the blocks of data from the first actuator and the second actuator to a disk controller in the multi-actuator disk drive, assemble in the disk controller a data stream containing the groups of blocks of data received from the first actuator and the second actuator, and send the data stream to a storage controller coupled to the multi-actuator disk drive.
